(19) United States
(12) Patent Application Publication
(10) Pub. No.: US 2011/0101059 A1
(43) Pub. Date: May 5, 2011

(54) Personal storage device mountable to a bicycle

(76) Inventors: Gregory Martin Haralson, Laguna Niguel, CA (US); John Bosilkovski, Shelby Township, MI (US)

(21) Appl. No.: 12/799,241

(22) Filed: Apr. 22, 2010

Related U.S. Application Data
(60) Provisional application No. 61/172,123, filed on Apr. 23, 2009.

(51) Int. Cl. B62J 7/00; B62J 7/06

(52) U.S. Cl. 224/421; 224/463

(57) ABSTRACT

A personal storage device has been created that is secured at the neck of the bicycle and rests on the cross bar. The personal storage device is composed of a nylon shell reinforced with a semi-dense foam. The personal storage device has an interior cavity for personal storage, but also has a pocket located in the flap of the personal storage device for holding personal media devices in the form of phones and mp3 players. The flap has a transparent window thin enough to allow the cyclist to operate any personal media device located within the pocket through the window. The personal storage device further provides an opening running from the interior cavity to the exterior for cables or cords connected from the personal media device to the cyclist. The entire personal storage device provides a virtual water tight seal for any components stored within.

### PRIORITY

This application claims prior to a provisional application Ser. No. 61/172,123 entitled “Bike Pak that enables a user to interact with the iphone . . . ” filed Apr. 23, 2009.

### BACKGROUND OF THE INVENTION

The problem that is addressed with the present invention is: cyclist wanting to use their cell phone or other electronic devices while continuing to ride a bicycle. Historically, cyclists have had to store the electronic device on either a hard mounted holder or on the inside of a backpack. By having to store the phone or device in this fashion, the cyclist has to stop their ride and open their backpack, usually located on their actually back or under the bicycle seat, in order to use the phone or device. This causes the cyclist to either stop the ride, or at least, divert a good deal of attention away from the cycling. This problem continues to rise as an elevated number of cyclist begin to use i-PHONES or other electronic devices with increasing customized user applications such as map applications, GPS applications, and applications designed to display cycling speed. In addition, because of the historically storage problems associated with storing phones or electronic devices during cycling, cyclists do not have a convenient way to see when people are calling or sending them text messages. This puts cyclists at a disadvantage when trying to utilize today's technology.

### SUMMARY OF THE INVENTION

It is an object of the present invention to provide a bicycle rider with a convenient personal storage device for which the cyclist can conveniently access their personal items, electronic or otherwise, while riding their bicycle without disrupting the cycling process.

In is another object of the present invention to provide a bicycle rider with a convenient personal storage device which can house a personal electronic media device which is viewable to the rider and which can be conveniently controlled by the rider, through a thin clear plastic interface, while still maintaining control of their bicycle.

It is yet another object the present invention to provide a bicycle rider with safe and convenient audio communication access while continuing to ride their bicycle.

The objectives of the present invention are accomplished by providing a personal storage device that is mountable at the neck of the bicycle and supported by the cross-bar and held in place by normally three attachment mechanisms: one located on the upright of the handle bar neck, and two located on the upper-most cross bar coming off the handle bar neck. The personal storage device includes a main body constructed of a first bottom, four side walls and a flap. The personal storage device is accessible by easily unfastening the attachment means running from second side wall to a third side wall to a fourth side wall and located between the three walls and a flap. The flap is further comprised of a second bottom wall and a top wall which are fastened together to form a pocket; the pocket being accessible by an opening located inside the main body and directly adjacent the first side wall. The flap is partially composed of a thin transparent material on the top wall which makes any phone or electronic device stored in the pocket visible to the cyclist. The pocket serves to securely maintain a personal media device therein. The transparent material is thin and flexible enough tO allow a user to control the phone or electronic device located within the pocket without removing it. Furthermore, the main body includes a small opening located on the first side wall that couples the interior of the main body to the exterior of the main body so that an audio communications cable or cord can be run from the personal media device (the phone or other electronic device) located either in the main body or the flap pocket to the corresponding cyclist.

### BRIEF DESCRIPTION OF THE DRAWINGS

FIG. 1 is a perspective view of the personal storage device mountable to a bicycle with the flap of the personal storage device in the open position.

FIG. 2 is a side view of the personal storage device mountable to a bicycle with the flap of the personal storage device in the open position with a personal media device being inserted into the flap pocket.

FIG. 3 is a perspective view of the personal storage device mountable to a bicycle with the flap of the personal storage device in the closed position and a personal media device in the flap pocket.

FIG. 4 is a top view of the personal storage device mountable to a bicycle with the flap of the personal storage device in the closed position and a personal media device in the flap pocket.

FIG. 5 is a bottom view of the personal storage device mountable to a bicycle.

FIG. 6 is a side view of the personal storage device mountable to a bicycle with the flap of the personal storage device in the closed position actually mounted to a bicycle.

FIG. 7 is a cross section of the sandwiched or layered construction of the material of the majority of the personal storage device.

### DETAILED DESCRIPTION OF PREFERRED EMBODIMENTS OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

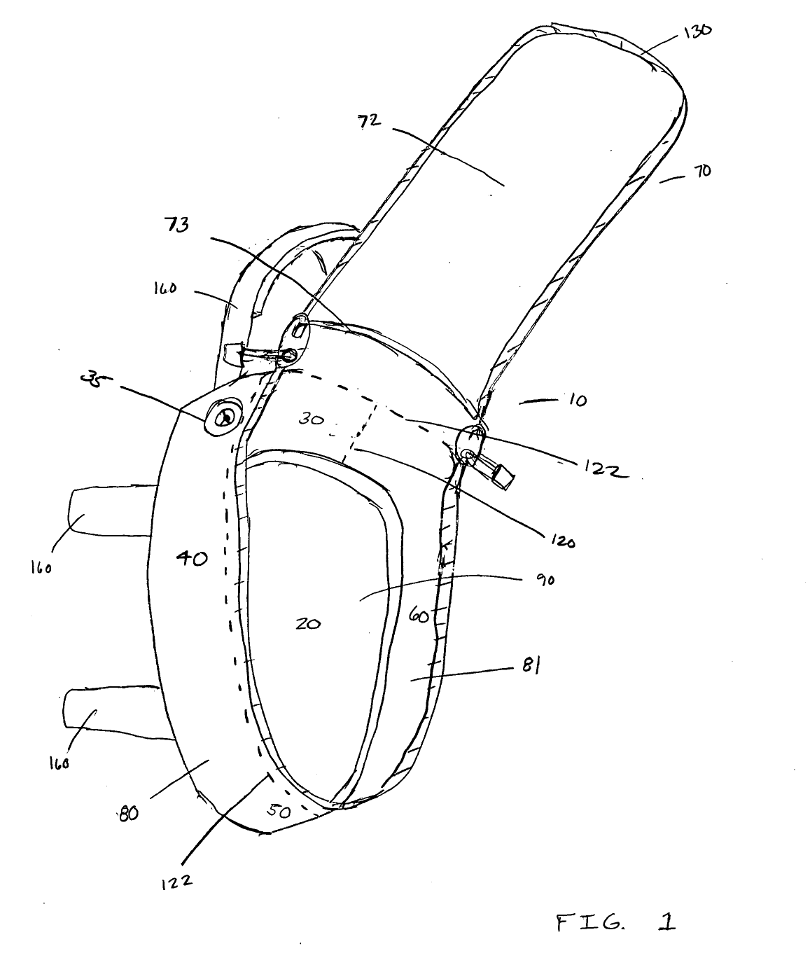

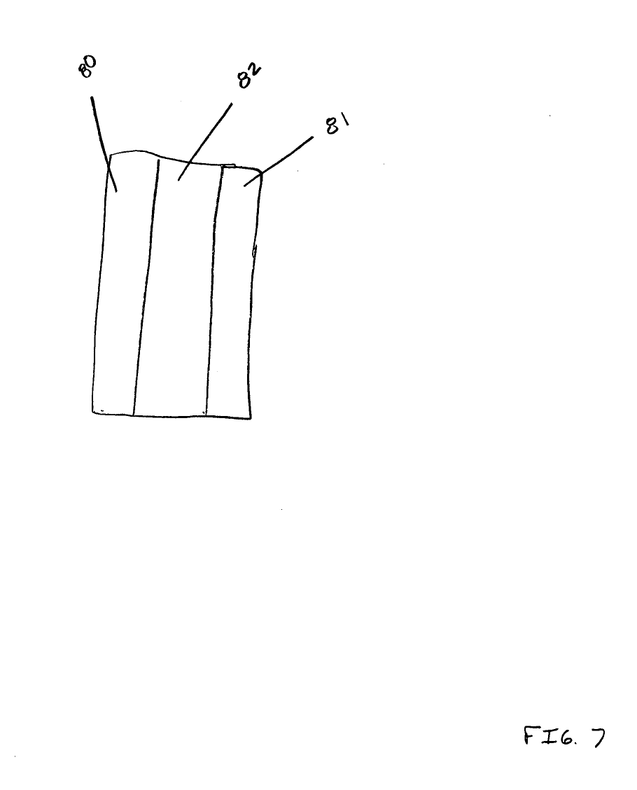

FIGS. 1-7 illustrate one embodiment of a personal storage device mountable to a bicycle, item 10, according to the present invention.

Herein, “personal media device” is defined to refer to any type of personal phone or electronic device used for personal enjoyment or personal advancement. These types of devices normally consist of cell phones (including i-PHONES), mp3 players (including i-PODS), personal GPS systems, but may range to any other type of typical electronic, hand-held devices used for communication, personal enjoyment, or personal advancement.

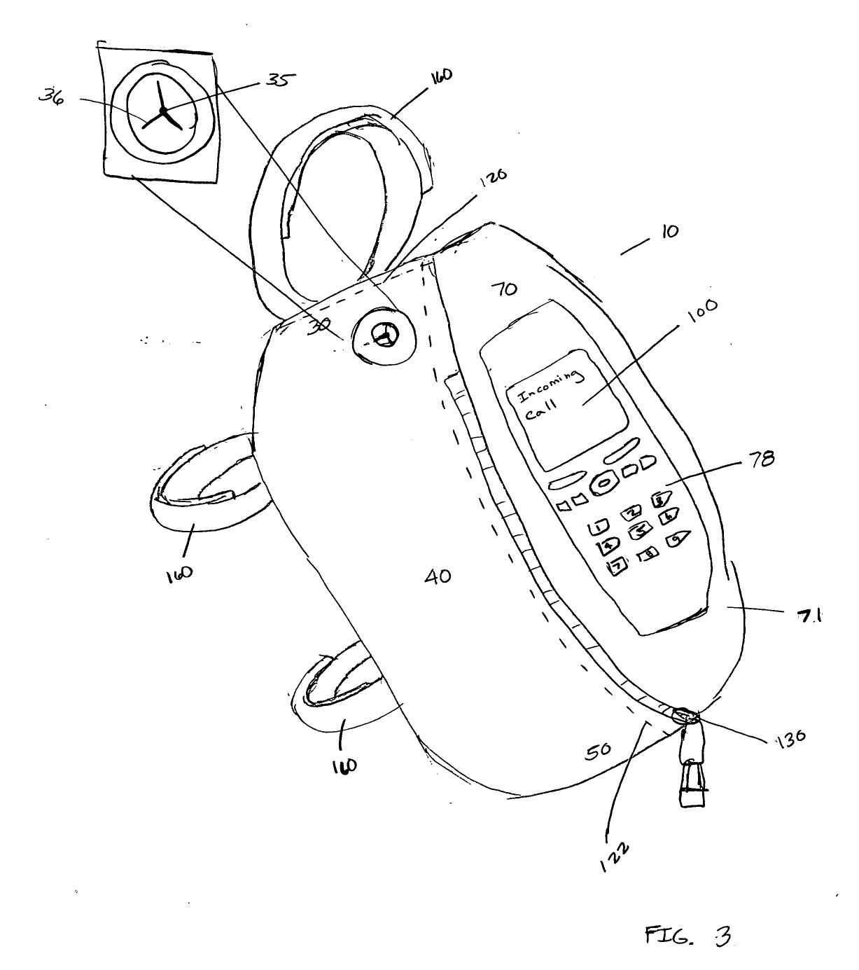

Referring to FIG. 1, the personal storage device 10 has a main body consisting of a first bottom wall 20, a first side wall 30, a second side wall 40, a third side wall 50, and a fourth side wall 60. Permanently attached to the first side wall 30 is a flap 70. The second side wall 40 and the fourth side wall 60 are generally linear and parallel to each. The first side wall 30 and the third side wall 50 are normally slightly curved outwardly and are mirror opposites about a central axis 150 passing through the second and fourth sides, as best shown in FIG. 3. The outwardly curved shape, of the first side wall 30 and third side wall 50 help to maintain the structural rigidity of the personal storage device in that they help to keep the second side wall 40 and fourth side wall 60 from bowing during use. However, it should be realized that all the side walls can be parallel in a rectangular type fashion or that the second wall 40 and fourth side wall 60 may be bowed, rather than the first and third side walls, in order to maintain the structural rigidity of the personal media device 10.

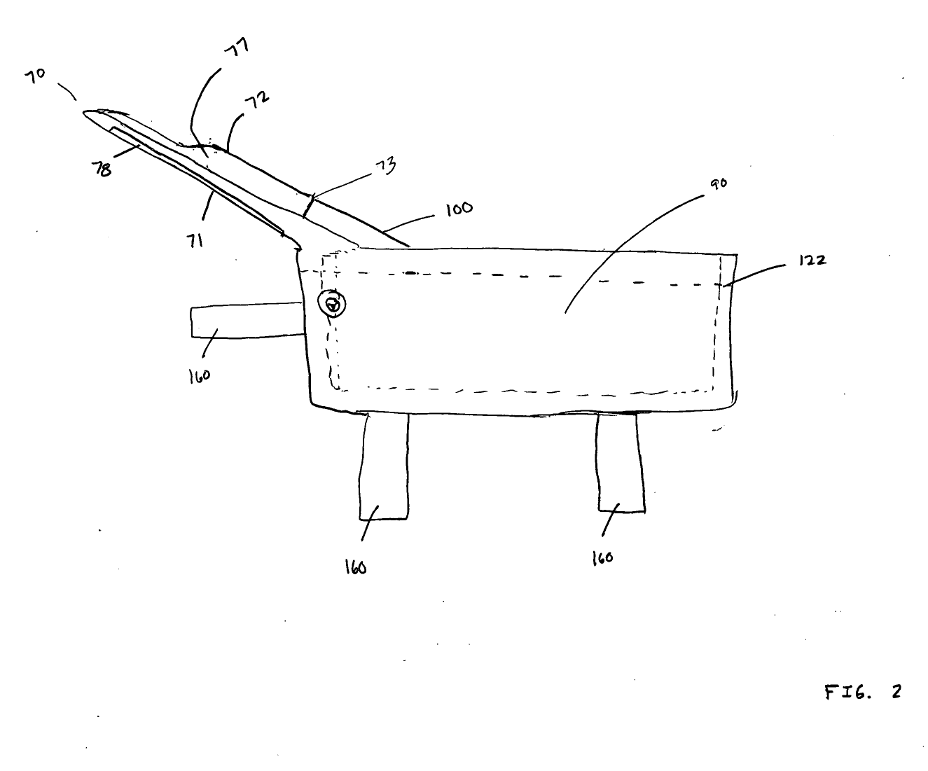

As stated previously, flap 70 is typically permanently attached to the first side wall 30 along the sewn/stitch line 122. It is noted that the flap may be removable coupled to the first side wall 30 so that the entire flap may be removed. However, based on preferred embodiment, the flap 70 is permanently attached to the first side wall 30, and the selected flexible nylon and foam material and construction of the personal storage device allow the intersection of the flap 70 and the first side wall 30 to act as a hinge. This hinge effect allows the flap 70 to be repeatedly opened, as seen in FIG. 1, and closed, as seen in FIG. 3. This hinging effect allows the cyclist access to the central storage compartment, or interior cavity 90, of the main body while keeping the flap 70 permanently attached to the personal storage device body. This lack of a historic visible hinge, or any corresponding pivoting mechanical parts, is crucial as it allows the flap 70 to be opened but maintains the structural integrity of the personal storage device 10. That is, the lack of a historic visible hinge or any mechanical pivoting parts helps to maintain a virtual water-tight seal of the personal storage device 10 and keeps any water from damaging the personal media device 100, or any other contents, contained therein. The flap 70 is further comprised of a second bottom wall 72 attached on three sides of the perimeter to a top wall 71, usually fashioned together by stitching/sewing at the perimeter. The second bottom wall 72 is normally made of a stretch elastic and flexible material. This stretch elastic material helps to hold the personal media device 100 against the transparent plastic window 78 so that the cyclist can easily control the personal media device 100 by pressing down on the transparent plastic window 78. In addition, the top wall 71 is placed in direct contact or on top of the second bottom wall 72. That is, top wall 71 and the second bottom wall 72 lie directly adjacent to each other. By connecting the second bottom wall 72 to the top wall 71 at three sides on the perimeter and by having the second bottom wall 72 and the top wall 71 placed in direct contact, a retaining slip pocket 77 is formed by the flap 70. The slip pocket 77 is directly accessible by an opening 73 placed adjacent the first wall 30 as best seen in FIGS. 1 and 2. While in the preferred embodiment, the opening 73 is placed adjacent or proximate the first side wall 30, it is noted that the opening can be placed in any location and proximate any side. In addition, while it is preferred that the opening 73 is located within the cavity 90 of the personal storage device 10, it is also noted that opening 73 may be place on the outside and may be kept shut by means well known in the art including: VELCRO, zipper, button or snap, or any other suitable means.

Referring to FIG. 2, the slip pocket 77 is directly accessible at opening 73. A personal media device 100 can be inserted at opening 73 into a slip pocket 77. As mentioned above, the elastic stretch material of the second bottom wall 72 helps contain the personal media device 100 snuggly within the slip pocket 77. As can be seen, the personal media device 100 fits tightly into the slip pocket 77 and is in directly contact with both the second bottom wall 72 and the top wall 71. This snug fit for the personal media device 100 is essential because it allows the cyclist to control the personal media device 100 by pressing down on it while it is maintained in slip pocket 77. The snug fit also allows the cyclist to open the flap 70 without the personal media device 100 sliding out of the slip pocket 77. The cyclist knows how to control the personal media device 100 because the personal media device can be easily seen through the top wall 71. This is accomplished because top wall 71 is comprised of both an opaque nylon material, consistent with the rest of the personal storage device, and a thin, vinyl or plastic, transparent window 78. Thus, when the personal storage device 100 is inserted into the slip pocket 77 with the top of the device facing the top wall 71, or towards the cyclist's face, the user can see the device clearly through the transparent window 78. This is best shown in FIGS. 2 and 3. The window 78 is typically constructed of vinyl, but any thin, clear, flexible material will work. It is necessary that the material both be clear and thin, and thus flexible, as the cyclist will need to press down on the flexible material in order to control the personal storage device 100. In the preferred embodiment, the transparent window is roughly 3 to 4 inches high and roughly 2 to 3 inches wide. These dimensions are suitable to accommodate and thus see most personal media devices, but it is noted that the window may be expanded or decreased in size as is necessary and may take up virtually the entire top wall 71 of flap 70. The transparent window is attached to the top wall 71 by a single sewn/stitched seam running around the perimeter of the window (not shown).

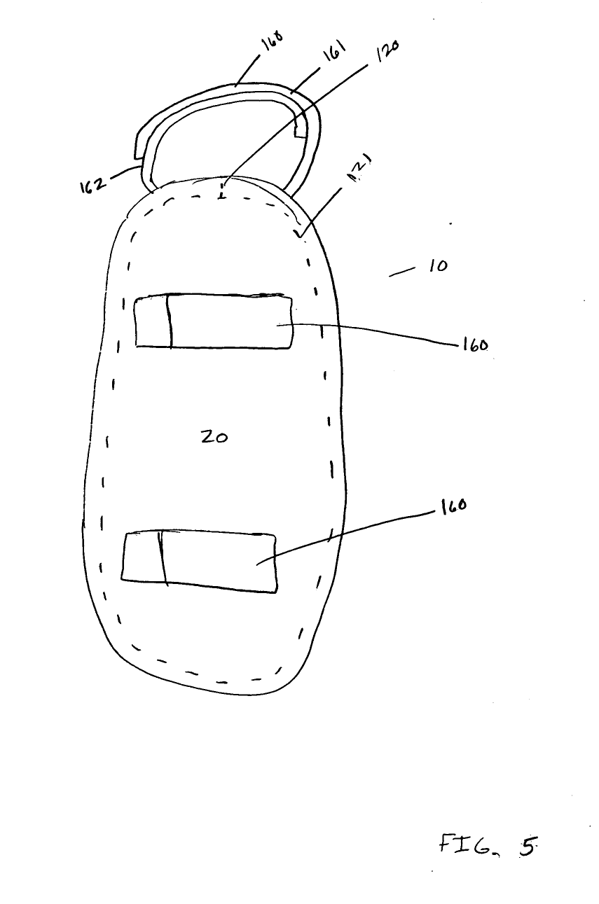

Referring to FIGS. 1 through 3 and 7, the body of the personal storage device 10 (i.e. the first bottom wall, first, second, third, and forth side walls) is constructed of layers comprising an outer layer 80, a middle semi-dense foam frame 82, and an inner layer 81. In the preferred embodiment, the outer layer 80 and inner layer 81 are constructed of a durable nylon, but it is noted that any flexible and durable material may be used. It is also noted that outer layer 80 and inner layer 81 may be made of the same material or different materials. The semi-dense foam frame 82 is made of a high-density foam. The high-density foam frame helps the side walls and first bottom wall retain their shape and provides the necessary rigidity to the structure. The outer layer 80, the semi-dense foam frame 82, and the inner layer 81 are sewn together, or sandwiched, to create the majority of the structure of the personal storage device 10. In the preferred embodiment, the first, second, third and fourth side walls are constructed using this three layered or sandwiched fashion by using a single inner piece of nylon, a single middle foam frame, and a single nylon inner piece, and simply connecting them together by a single sewn/stitched connection 120 lying in the middle of the first side wall, as best seen in FIGS. 1 and 3. The outer nylon layer 80 helps to keep the personal storage device 10 virtually waterproof. The inner nylon layer 81 allows for the inside to be easily cleaned. The sandwich construction keeps the foam 82 from deteriorating as no foam frame 82 is left exposed when the personal storage device 10 is assembled or sewn together. In addition, the semi-dense foam 82 helps to create the first and third side walls, 30 and 50 as curved, and the second and fourth side walls, 40 and 60 as straight and parallel. The first bottom wall 20 is also constructed in the same layered or sandwiched fashion again using a single nylon outer piece, a single middle foam frame, and a single nylon inner piece. The layered first bottom wall 20 is connected to the layered side walls, 30, 40, 50, and 60, by a single sewn/stitched connection 121 running around the perimeter of the first bottom wall 20 as best seen in FIG. 5.

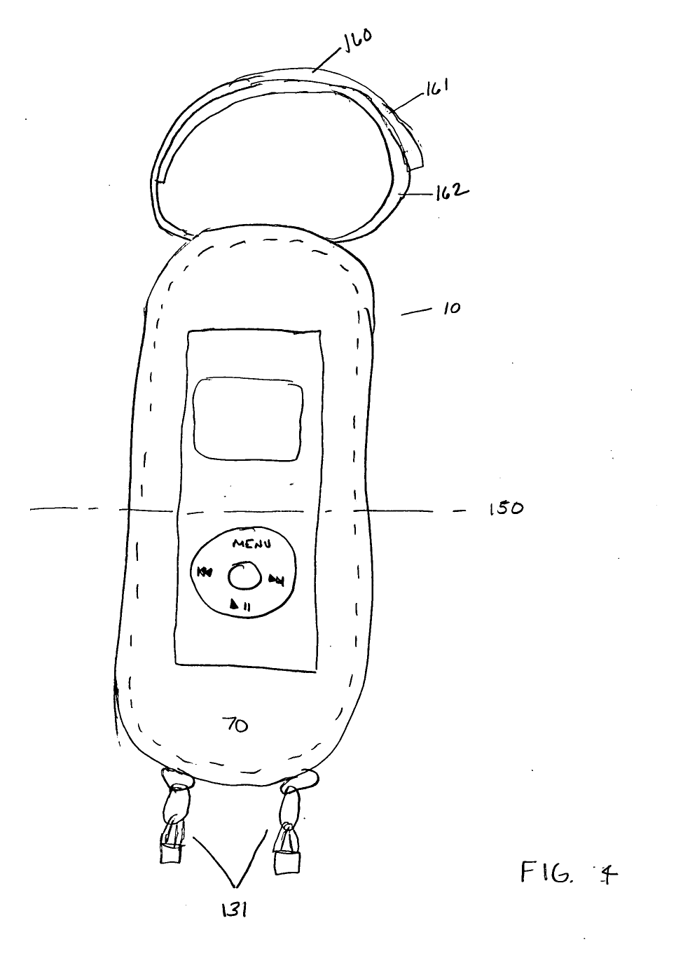

Referring to FIGS. 1 and 3, the body of the personal storage device 10 is completed by attaching the flap 70 to the first side wall 30 of the body. This connection is again accomplished a single sewn/stitched connection 122 running around the entire perimeter of the body (i.e. all four side walls, 30, 40, 50, and 60). As best seen in FIG. 3, the single sewn/stitched connection 122 accomplishes two purposes. First, it permanently attaches the flap 70 to the body at the first side wall 30. Second, the single sew/stitched connection connects a zipper 130 to the body along the second, third, and fourth sides walls allowing a portion of flap 70 to be temporarily disengaged. The other half of the zipper 130 is attached to the perimeter of the flap 70 proximate the second, third, and fourth side walls by a single sewn/stitched seam (not shown). The disengagement of the zipper 130 allows the cyclist to open and close the flap 70 and gives access to the cavity 90 as well as pocket 77 via opening 73 that is only accessible through the inside body of the personal storage device 10 (i.e. cavity 90). While the preferred embodiment uses a zipper 130 to temporarily secure a portion of the flap 70 to the rest of the body, it is noted that any other means for closure may be used to temporarily close off cavity 90 including those well known in the art: VELCRO, button or snap, or any other suitable means. It is noted, as best seen in FIG. 4, that in the preferred embodiment, two sliders 131 are used with the zipper 130 to allow more convenient access to the cavity 90. Once temporary access to the cavity 90 has been accomplished, the cyclist may close the personal storage device 10 by zipping up zipper 130 and once again connecting the flap 70 to the body along the three side walls, 40, 50, and 60.

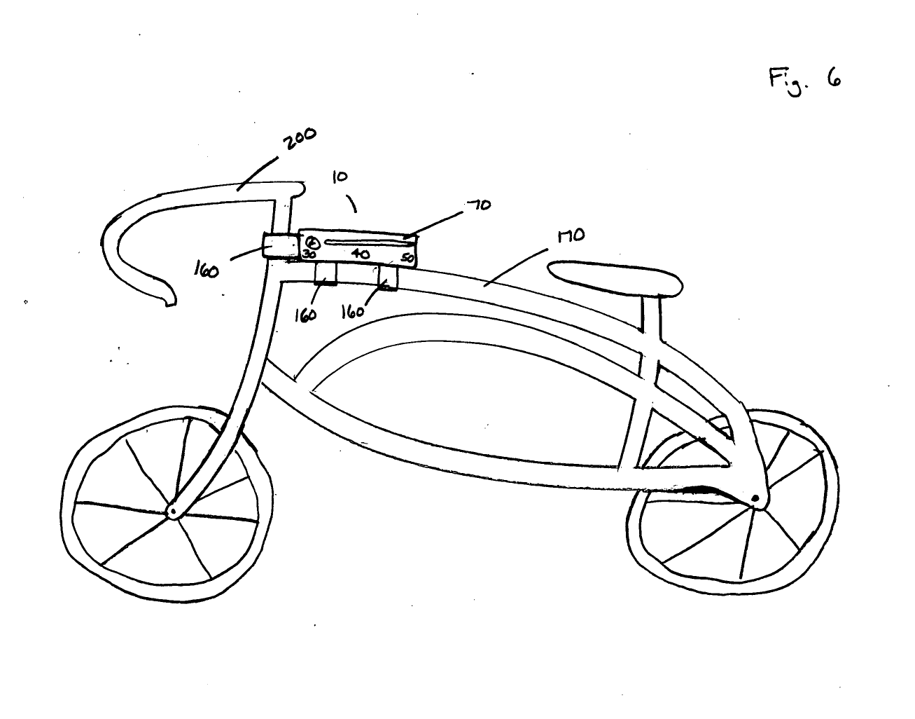

As best seen in FIGS. 1 and 3, the first side wall 30 also comprises an opening 35 that couples the inside of cavity 90 to the exterior or outside. The opening 35 is made of rubber or any other suitable polymer material. The opening 35 has three slits 36 in a star like fashion as best seen in FIG. 3 in magnified drawing. The three slits 36 come together at a single point to create the opening 35. The use of three slits 36 instead of a normal opening is important as it creates a virtual water tight seal through which communication cables or cords (not shown) may be run. The communication cables or cords (not shown) that run from the cavity 90 to the outside via opening 35 normally include audio communication cables or cords used by the cyclist in the form or head phones or ear pieces. These ear pieces or headphones are used in connection with the personal media device 100 or any other device stored in either pocket 77 or cavity 90, or both. In addition, since opening 73 is located proximate the first side wall 30 on which opening 35 lies, any communication cord running from the personal media device 100 can run unobstructed from the device 100 into the cavity 90 and out opening 35 to the cyclist. The location of opening 35 also allows the user to open the flap 70 and gain access to cavity 90 with no obstruction from the cord running from the device 100 to the user. As shown in FIG. 6, it is also noted that, based on the placement of the personal storage device 10 on the bicycle 170, the personal storage device 10 works well with BLUETOOTH technology as the cyclist's head rides virtually above the device 10 and thus any personal media device 100. Thus, the cyclist may not have to utilize the opening 35 as no cord or cable may be necessary.

Using the structure as defined above, the personal storage device 10 accomplishes two purposes. First, a personal media device 100 may be stored in the pocket 77. In addition, additional items may be stored in virtual water tight cavity 90. These additional items may include credit cards, keys, audible components, money, etc. In the preferred embodiment, the personal storage device 10 measures around 3.5 inches wide, 6.5 inches long, and 3 inches high. However, typical measurements can range from 2 to 5 inches wide, 5 to 10 inches long, and 2 to 6 inches high. The smaller size and aerodynamic shape of the personal storage device 10 ensure that the device 10 produces minimal drag and thus has no ill-effect on a cyclists performance, is small enough to be fully supported by the cross-bar, and yet is large enough to store personal items.

Finally, as best seen in FIGS. 1 through 6, the personal storage device 10 has attachment means 160 for securing the personal storage device 10 to a bicycle 200. In preferred embodiment, the attachment means 160 takes the form of two strips of VELCRO, commonly called hook and loop fastener. As best seen in FIGS. 4 and 5, the attachment means 160 is comprised of the first strip 161 having the hook portion, and the second strip 162 have the loop portion. The attachment means 160 is permanently attached to the body of personal storage device 10 at several locations on the exterior of the personal storage device 10. Most notably, a single attachment means 160 is sewn/stitched onto the first side wall 30 as best seen in FIGS. 4 and 5. Two more attachment means 160 are sew/stitched onto the first bottom 20 as best seen in FIG. 5. In the preferred embodiment, strips 161 and 162 range in 4 to 6 inches, but it is noted that any size can be used based on the desired application. Because hook and loop fastener strips are used with infinite amounts of adaptability, the attachment means 160 can be adapted to fit any diameter of neck and cross-bar. As best seen in FIG. 6, the attachment means 160 located on the first side wall 30 is necessary to secure the personal storage device 10 to the neck-bar of the bicycle 200. The other two attachment means 160 located on the first bottom wall attach the personal storage device 10 to the cross-bar of the bicycle 200. By have the personal storage device 10 located at the neck of the bicycle, the cyclist can simply look down into the transparent window to operate the personal media device 100. The cyclist can operate the personal media device 100 with little attention diverted from his cycling, and gain access to cavity 90 through flap 70 with out having to stop. While in the preferred embodiment, one attachment means is used on the first side wall, and two attachment means are used on the first bottom wall, it is noted that any number of attachment means can be used on these two surfaces. While the preferred embodiment uses a hook and loop fasteners to attach the body 10 to the bicycle 170, it is noted that any other means for attachment may be used, including those well known in the art: button or snap, clip, tying, clamping, or any other suitable means.

We claim:

1. A personal storage device directly mounted to a bicycle, the personal storage device comprising: a body comprising
a first bottom wall made of a material and having a perimeter,
a first side wall, a second side wall, a third side wall, and a fourth side wall made of a material, having an exterior surface, and connected to the perimeter of the first bottom to create an interior cavity; and
a flap made of a material, having a perimeter and permanently connected to the first side wall to create an enclosure.

2. The personal storage device of claim 1, wherein said flap is further comprised of a second bottom wall and a top wall, said second bottom wall and said top wall attached at a portion of said flap perimeter in order to create a pocket with an opening.

3. The personal storage device of claim 2, wherein said second bottom wall is comprised of an elastic or stretch material capable of snugly retaining an object in said pocket.

4. The personal storage device of claim 2, wherein said opening is located proximate or adjacent the first wall.

5. The personal storage device of claim 2, wherein said material of said top wall is further comprised of both a transparent material portion and a durable nylon material portion wherein said transparent material portion creates a viewing window for said pocket.

6. The personal storage device of claim 5, wherein said transparent material is sufficiently flexible enough to allow a user to operate through said transparent material a personal media device housed in said pocket.

7. The personal storage device of claim 6, where said transparent material is vinyl.

8. The personal storage device of claim 1, wherein the material of the first bottom wall, first side wall, second side wall, third side wall, and fourth side wall is a three layered construction of nylon, followed by foam, followed by nylon.

9. The personal storage device of claim 1, wherein at least one means for attachment is permanently placed on said exterior surface of said first side wall and said exterior surface of said first bottom wall.

10. The personal storage device of claim 9, wherein said means for attachment is a hook and loop fastener strip.

11. The personal storage device of claim 10, wherein said hook and loop fastener strips are capable of being fastened around a neck and cross bar of a bike.

12. The personal storage device of claim 1, wherein said first wall further comprises an opening coupling said interior cavity to said exterior surface of said first wall.

13. The personal storage device of claim 12, wherein said opening is capable of allowing a communications cable or cord to run from said interior cavity to a head of a cyclist.

14. The personal storage device of claim 1, wherein a means for closure releasably couples said first, second, and third side walls with a portion of said perimeter of said flap.

15. The personal storage device of claim 14, wherein said means for closure is a zipper.

16. The personal storage device of claim 1, wherein said first and third walls are curved outwardly and away from said interior cavity and said second and fourth walls are straight and parallel.

17. The personal storage device of claim 1, wherein said body measures approximately 2 to 5 inches wide, 5 to 10 inches long, and 2 to 6 inches high.

18. A personal storage device directly mounted to a bicycle, the personal storage device comprising: a body comprising
a first bottom wall made of a material and having a perimeter;
a first side wall, a second side wall, a third side wall, and a fourth side wall made of a material, having an exterior surface, and connected to the perimeter of the first bottom to create an interior cavity;
a flap made of a material, having a perimeter and permanently connected to the first side wall to create an enclosure; and
wherein said flap is further comprised of a second bottom wall and a top wall, said second bottom wall and said top wall attached at a portion of said flap perimeter in order to create a pocket with an opening.

19. A personal storage device directly mounted to a bicycle, the personal storage device comprising: a body comprising
a first bottom wall made of a material and having a perimeter;
a first side wall, a second side wall, a third side wall, and a fourth side wall made of a material, having an exterior surface, and connected to the perimeter of the first bottom to create an interior cavity; and
a flap made of a material, having a perimeter and permanently connected to the first side wall to create an enclosure; and
at least one hook and loop fastener strip placed on said exterior surface of said first side wall and said exterior of said first bottom wall capable of being fastened to a neck and cross bar of a bike.
